(19) United States
(12) Patent Application Publication
(10) Pub. No.: US 2009/0320578 A1
(43) Pub. Date: Dec. 31, 2009

(54) TEST APPARATUS FOR A JET ENGINE

(76) Inventors: Arnold A. Peltzer, Ramsey, MN (US); David J. Sowl, Brooklyn Center, MN (US); Kelley D. Kimball, Lino Lakes, MN (US)

Correspondence Address: PEARNE & GORDON LLP, 1801 EAST 9TH STREET, SUITE 1200, CLEVELAND, OH, 44114-3108, US

(21) Appl. No.: 11/683,223

(22) Filed: Mar. 7, 2007

(51) Int. Cl. G01M 15/14

(52) U.S. Cl. 73/116.03

(57) ABSTRACT

A test apparatus can include a jet engine and a first frame configured to support the jet engine. In one example, the test apparatus can include means for flexibly coupling the jet engine to the first frame to allow movement between the jet engine and the first frame during a test procedure. In another example, a test apparatus is provided that is configured to support a jet engine. The test apparatus can include a frame, a flex member, a first attachment element and a second attachment element. In yet another example, a test apparatus can be provided with a frame, a flex member and a limiting element.

### FIELD OF THE INVENTION

The present invention relates generally to testing, and more particularly to test apparatus for a jet engine.

### BACKGROUND OF THE INVENTION

Gas turbine engines are commonly employed for providing power to an aircraft during operation. Such jet engines have various moving parts that may develop undesirable vibrations that can damage engine parts and/or cause vibrations to propagate throughout the aircraft.

In order to minimize vibratory concerns, jet engines are commonly mounted on a test stand to conduct ground testing at various levels of output power. One example of a jet engine testing configuration is disclosed by U.S. Pat. No. 5,396,791. The '791 patent discloses a flexible adaptor for mounting an aircraft gas turbine engine to a test stand.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a test apparatus is provided with a jet engine and a first frame configured to support the jet engine. The test apparatus further comprises means for flexibly coupling the jet engine to the first frame to allow movement between the jet engine and the first frame during a test procedure.

In accordance with another aspect of the present invention, a test apparatus comprises a jet engine and a first frame configured to support the jet engine. The test apparatus further comprises a flex member including a mount interface coupled to the jet engine and configured to apply a force in a first direction to counteract a weight of the jet engine. The test apparatus also includes a first attachment element pivotally coupling the flex member to the first frame about a first axis extending substantially perpendicular to the first direction. The test apparatus still further includes a second attachment element positioned between the first attachment element and the mount interface and pivotally coupling the flex member to the first frame about a second axis extending substantially parallel with respect to the first axis. The flex member provides a cantilever support for flexibly supporting the jet engine with respect to the first frame.

In accordance with still another aspect of the present invention, a test apparatus is provided that is configured to support a jet engine. The test apparatus includes a frame and a flex member including an elongated member extending between a first portion coupled to the frame and a mount interface configured to be coupled to a jet engine. The elongated member is configured to flex to allow movement of the mount interface with respect to the frame along a first direction during a test procedure. The test apparatus further includes a first attachment element pivotally coupling the first portion of the flex member to the frame about a first axis extending substantially perpendicular to the first direction. The test apparatus further includes a second attachment element positioned between the first attachment element and the mount interface and pivotally coupling the first portion of the flex member to the first frame about a second axis extending substantially parallel with respect to the first axis.

In accordance with yet another aspect of the present invention, a test apparatus is provided that is configured to support a jet engine. The test apparatus includes a frame and a flex member. The flex member includes an elongated member extending between a first portion coupled to the frame and a mount interface configured to be coupled to a jet engine. The elongated member is configured to flex to allow movement of the mount interface with respect to the frame during a test procedure. The test apparatus further includes a limiting element configured to limit movement of the mount interface with respect to the frame.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a side view of an example test apparatus in accordance with aspects of the present invention;

FIG. 2 illustrates a sectional view of portions of the test apparatus of FIG. 1; and

FIG. 3 illustrates an example flex member in accordance with aspects of the present invention.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

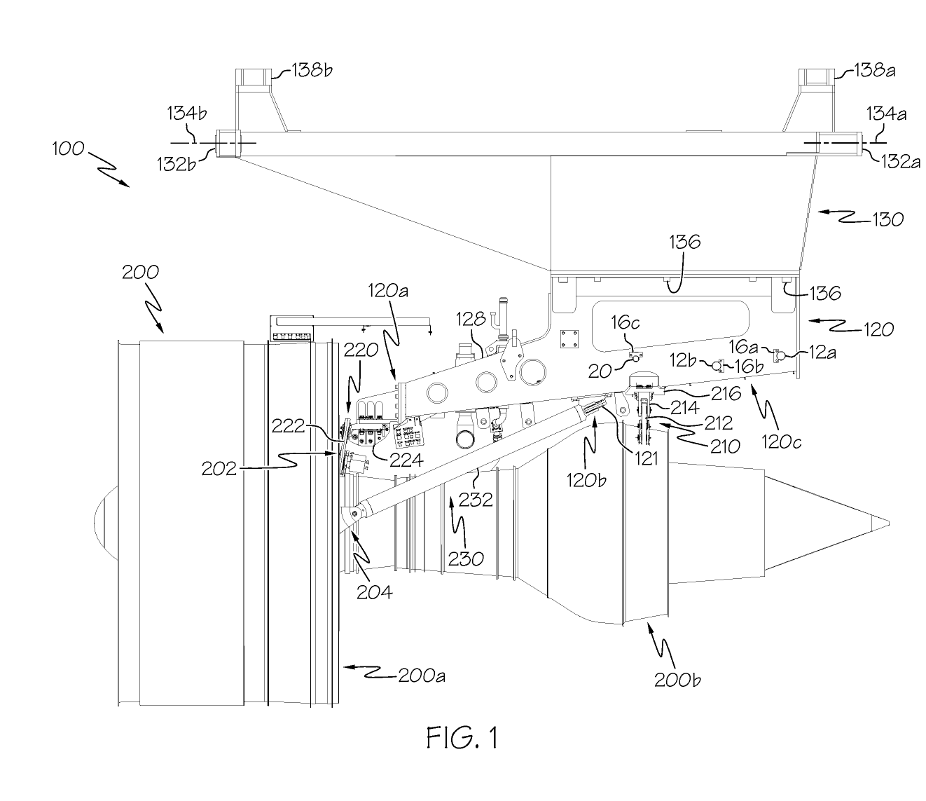

Turning to the shown example of FIG. 1, a test apparatus 100 is provided. The test apparatus 100 is configured for attachment to a test stand (not shown) so various test procedures may be carried out for a jet engine 200. In one example, the test apparatus 100 includes the jet engine 200 while other examples provide the test apparatus 100 separately for use with the jet engine. Accordingly, the jet engine 200 may be considered an optional component of the test apparatus 100. For instance, the test apparatus 100 may be assembled and sold separately without a jet engine with the understanding that the jet engine 200 will later be incorporated as part of the test apparatus at the test site. In further examples, the test apparatus 100 may be assembled, e.g., at the test site, with the jet engine 200 included as part of the test apparatus 100.

The test apparatus 100 can further include a frame configured to support the jet engine 200. Suitable frames can be constructed with various materials and configurations in order to support the weight of the jet engine 200 and support the jet engine 200 during testing procedures. In the illustrated example shown in FIG. 1, the frame can include a first frame 120 configured to support the jet engine 200. As further shown in FIG. 1, an optional second frame 130 may be provided that can be substantially rigidly attached to the first frame 120. A wide range of fastening methods may be employed to substantially rigidly attach the second frame 130 to the first frame 120. For example, as shown, the second frame 130 is substantially rigidly attached to the first frame 120 by way of a plurality of fasteners 136, clamping arrangements or other mechanical fastening techniques. In still further examples, the second frame 130 may be integrally welded to the first frame 120, or otherwise formed as an integral portion of the first frame.

The second frame 130, if provided, can be configured for mounting to a test stand (not shown). The test stand can comprise a stand supported by a floor, ceiling or wall of a building or other support structure. As shown, for example, the second frame 130 includes optional bushings 132a, 132b extending through bores along center lines 134a, 134b. The second frame 130 can also include first and second outwardly extending support brackets 138a, 138b. A second set of identical bushings and outwardly extending brackets are also found on the opposite side of the second frame (not shown) wherein the second set of bushings and outwardly extending brackets are a mirror image of the first set of bushings and outwardly extending support brackets about a symmetric axis of the second frame 130. The support brackets 138a, 138b together with the bushings 132a, 132b provide one example configuration that allows the second frame 130 to be removably mounted to the test stand (not shown).

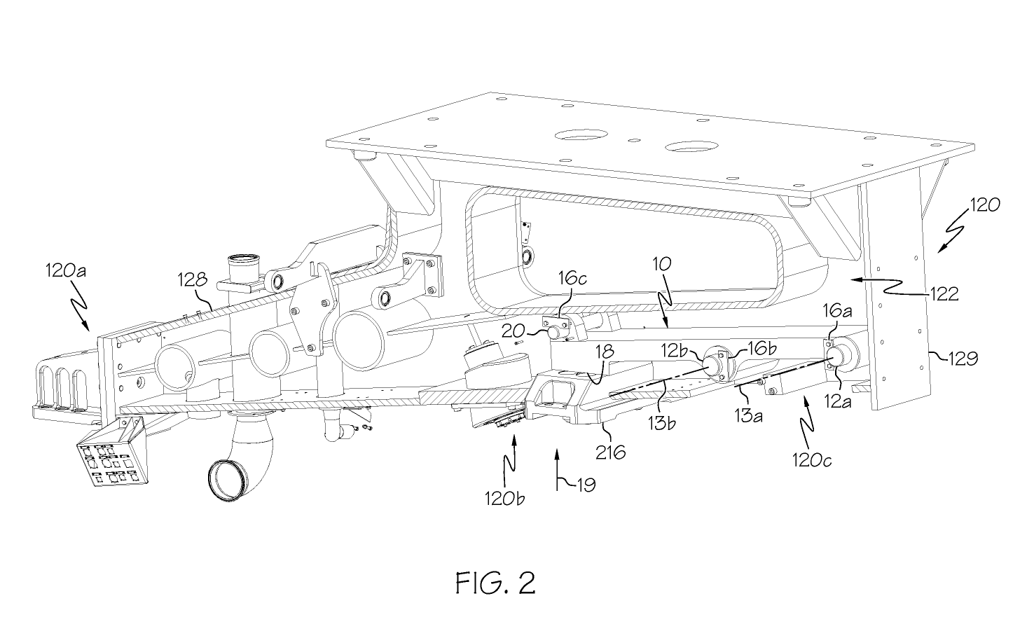

FIG. 2 illustrates a sectional view of the first frame 120 shown in FIG. 1 wherein a side plate of the first frame 120 has been removed to illustrate an interior area 122 of the first frame 120. As shown in FIG. 2, examples of the first frame 120 can include a base 129 and a support beam 128 extending from the base 129.

The jet engine 200 can be supported in a wide variety of ways. For example, as shown in FIG. 1, the first frame 120 can support a front portion 200a of the jet engine 200 and a rear portion 200b of the jet engine 200. In one example, the jet engine 200 can include a rear engine mount configuration 210 for supporting the rear portion 200b of the jet engine 200 and first and second front engine mount configurations 220, 230 for supporting the front portion 200a of the jet engine 200. The rear engine mount configuration 210 can include one or more link members 212 and a link bracket 214. An adapter plate 216 can be provided to substantially rigidly mount the link bracket 214 of the rear engine mount configuration 210 to a mount interface 18 of a flex member 10 described more fully below.

The first front engine mount configuration 220 can be designed to substantially rigidly couple the front portion 200a of the jet engine 200 to the support beam 128 of the first frame 120. In one example, the first front engine mount configuration 220 can include a link 222 and a link bracket 224 to substantially rigidly connect a first portion 120a of the first frame 120 to the front portion 200a of the jet engine 200 at a first location 202. As shown, the support beam 128 can include the first portion 120a of the first frame 120. Once mounted, the support beam 128 can provide a cantilever support for the front portion 200a of the jet engine 200.

The second engine mount configuration 230 can be designed to substantially rigidly couple the front portion 200a of the jet engine 200 to the base 129 of the first frame 120. In further examples, the front portion 200a of the jet engine 200 can be substantially rigidly coupled to the base 129 and the beam 128 of the first frame 120.

As shown in the illustrated example, the second engine mount configuration 230 can include a pair of elongated struts 232 wherein one elongated strut 232 is shown in FIG. 1 and the other elongated strut is hidden behind the illustrated strut. The elongated struts 232 can be substantially identical to one another and symmetrically disposed about a central axis of the jet engine 200. Each elongated strut 232 provides a substantially rigid connection between a common link plate 121 connected at a second portion 120b of the first frame 120 and symmetrically disposed second locations 204 at the front portion 200a of the jet engine 200. In the illustrated example, the first location 202 can be substantially vertically offset from the second locations 204 although other orientations are contemplated in further examples. As shown, the base 129 can include the second portion 120b of the first frame 120 wherein the second engine mount configuration 230 provides a substantially rigid connection between the front portion 200a of the jet engine 200 and the base 129 of the first frame 120.

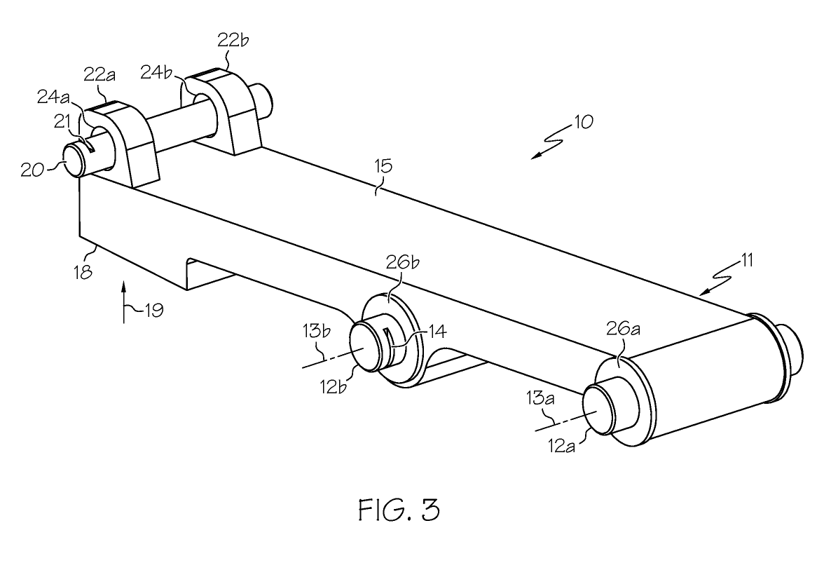

The test apparatus 100 can further include means for flexibly coupling the jet engine 200 to the first frame 120 to allow movement between the jet engine 200 and the first frame 120 during a test procedure. As shown in FIG. 3, the means for flexibly coupling can comprise a flex member 10, such as a flex beam, including a mount interface 18 configured to mount to the jet engine 200. The mount interface 18 is configured to be coupled to the jet engine 200 and apply a force, for example, in a first direction 19 to counteract a weight of the jet engine 200. The flex member 10 further includes structure configured to interact with a first attachment element 12a and a second attachment element 12b to mount a first portion 11 of the flex member 10 to the first frame 120. As shown in FIG. 3, the flex member 10 can include an elongated member 15 extending between the first portion 11 coupled to the first frame 120 and the mount interface 18. With such a configuration, the elongated member 15 can flex to allow movement of the mount interface 18 with respect to the first frame 120 along the first direction 19 during a test procedure.

Optionally, the test apparatus can further include means for limiting movement of the jet engine 200 with respect to the frame. For example, the test apparatus can comprise a limiting element 20 configured to limit movement of the mount interface 18 with respect to the frame 120. In further examples, means for limiting movement of the jet engine 200 can further include one or more elongated slots 24a, 24b defined by the flex member 10 that are configured to receive the limiting element 20, such as the illustrated limit pin. As shown in FIG. 3, the flex member 10 can optionally include one or more limiting ears 22a, 22b including the one or more elongated slots 24a, 24b. Although a single limiting ear may be provided, a plurality of limiting ears may be useful to limit shear and bending stresses that may be imposed on the limiting element 20. Although not shown, further examples may provide a flex member without limiting ears. For instance, one or more elongated slots may be formed within a portion of the flex member without ears extending from the flex member. The elongated slots, if provided can be oriented in a substantially vertical direction to limit a substantially vertical movement of the jet engine 200. In one example, the elongated slots can be designed to limit movement of the jet engine 200 along the direction 19. The elongated slots 24a, 24b and limiting element 20 can be designed to permit the flex member 10 to deflect without interference when subject to normal running loads. However, in the event of an engine failure or test event, the allowable deflection of the flex member 10 is restrained by the limited available travel of the limiting ears 22a, 22b with respect to the limiting element 20, thereby preventing overstressing of the flex member 10.

The flex member can be located in different positions with respect to the frame. For example, the flex member may be located on one side of the frame. As shown, the flex member 10 may also be at least partially positioned within an interior area 122 of the first frame 120.

As shown in the illustrated embodiment, the first attachment element 12a can pivotally couple the first portion of the flex member 10 to the first frame 120 about a first axis 13a extending substantially perpendicular to the first direction 19. Moreover, the second attachment element 12b can be positioned between the first attachment element 12a and the mount interface 18 and pivotally couple the first portion 11 of the flex member 10 to the first frame 120 about a second axis 13b extending substantially parallel with respect to the first axis 13a. As shown, for instance, the first and second attachment elements 12a, 12b can comprise respective pivot pins that are pivotally inserted through bores in the flex member 10. Once both pivot pins are inserted through the bores of the flex member 10 and corresponding apertures in the first frame 120, the first portion 11 of the flex member 10 can be supported in the position illustrated in FIGS. 1 and 2. Moreover, in the illustrated mounting arrangement, the flex member can provide a cantilever support for flexibly supporting the jet engine 200 with respect to the first frame 120. Indeed, once the first portion 11 is coupled to the first frame 120 and the mount interface 18 is coupled to the jet engine 200, the elongated member 15 extending between the first portion 11 and the mount interface 18 is configured to flex to allow movement of the mount interface 18 with respect to the first frame 120 during a test procedure. Moreover, once the jet engine 200 is mounted in place, it will be appreciated that the rear portion 200b of the jet engine 200 is flexibly coupled to the first frame 120 by the flex member 10 while the front portion 200a of the jet engine 200 is substantially rigidly coupled to the first frame 120. The support beam 128 can provide a cantilever support for the front portion 200a of the jet engine 200. Thus, the nature of the first frame 120 can permit limited movement of the front portion 200a of the jet engine 200 with respect to the second frame 130 and/or test stand due to the cantilever effect provided by the support beam 128 extending from the base 129 of the first frame 120.

The flex member 10 can be shaped and sized to provide the desired dynamic response as requested by engine manufacturers during engine development and during engine production testing. For example, the flex member 10 can be tuned to meet the requirements of the engine manufacturer such that the member 10 will flex the appropriate amount for a given load as developed by engine thrust, engine torque loads, and simulated failure loads. The first and second attachment elements 12a, 12b, such as the illustrated pivot pins, and the limiting element, such as the limiting pin 20, can be secured to the first frame 120 by retention clips 16a, 16b, 16c. Spacers 26a, 26b can be placed on each side of the flex member 10 to help keep the flex member 10 centered within the interior area 122 and free from possible interference inside the first frame 120.

The flex member 10 can be easily removed to enable one to easily tune the first frame 120 to meet dynamic requirements of a different engine with relative ease. Indeed, the retention clips 16a, 16b, 16c can be removed to allow replacement of the flex member 10 with another flex member tuned for a different flexibility requirement. Thus, the expensive first frame 120 can be adapted for testing engines having different thrust outputs from the same engine family.

One example procedure for assembling the test stand will now be described. Initially, a flex member 10 with the appropriate flexibility requirement is appropriately positioned within the interior area 122 of the first frame 120. Next, the pivot pins 12a, 12b and spacers 26a, 26b are appropriately positioned to provide flex points between the first portion 11 of the flex member 10 and the third portion 120c of the first frame 120. Retention clips 16a, 16b are then installed to maintain the pins 12a, 12b in position. The deflection limiting pin 20 can then be inserted into apertures in the first frame 120 and the elongated slots 24a, 24b of the limiting ears 22a, 22b and retained in position with respect to the first frame 120 by the retention clips 16c.

The jet engine 200 can then be moved in position with respect to the first frame 120 as shown in FIG. 1. The adapter plate 216 can then be used to substantially rigidly mount the link bracket 214 of the rear engine mount configuration 210 to the rear engine mount interface 18 of the flex member 10. Once the link bracket 214, adapter plate 216 and interface 18 of the flex member 10 are attached together, the rear portion 200b of the jet engine 200 is flexibly coupled, in a cantilever fashion, to the base 129 at the third portion 120c of the first frame 120.

The link bracket 224 of the first front engine mount configuration 220 can then be substantially rigidly mounted to the first portion 120a of the first frame 120. Once the link bracket 224 and first portion 120a are attached together, the first portion 120a of the first frame 120 is substantially rigidly attached to the first location 202 of the front portion 200a of the jet engine 200. The common link plate 121 of the second front engine mount configuration 230 is then substantially rigidly mounted to the second portion 120b of the first frame 120. Once the common link plate 121 and the second portion 120b are attached together, the second portion 120b of the first frame 120 is substantially rigidly attached to the second locations 204 with the elongated struts 232. As shown, example configurations can provide the second locations 204 vertically beneath the first location 202.

Accordingly, once mounted, the front portion 200a of the jet engine 200 is substantially rigidly coupled to the first portion 120a and the second portion 120b of the first frame 120. In example embodiments, the support beam 128 can include the first portion 120a and base 129 can include the second portion 120b. A rear portion 200b of the jet engine 200 is flexibly coupled to the third portion 120c of the first frame 120, wherein the base 129 includes the third portion 120c and wherein the second portion 120b is located between the first portion 120a and the third portion 120c of the first frame 120.

Once mounted, the rear portion 200b of the jet engine 200 is flexibly coupled, in a cantilever fashion, to the third portion 120c of the first frame 120 by the flex member 10. At the same time, the front portion 200a of the jet engine 200 is substantially rigidly coupled to the first and second portions 120a, 120b of the first frame 120 by the first and second front engine mount configurations 220, 230. Still further, the first frame 120 is designed such that the first and second portions 120b, 120c are substantially rigid in the vertical direction with respect to the upper frame 130. The support beam 128 extending from the base 129 provides limited vertical flexibility of the first portion 120a with respect to the upper frame 130.

The jet engine 200 can be operated to test vibrational characteristics of the jet engine with instrumentation associated with the test cell. The same first frame 120 may be used to test a wide range of engine types and characteristics. In order to vary the stiffness of the first frame 120, the flex member 10 may be simply removed and replaced with a new flex member having appropriate stiffness characteristics.

During testing, the flex member 10 flexibly decouples a rear portion 200b of the jet engine 200 for limited vertical movement of the rear portion 200b with respect to the upper frame 130 and base 129 of the first frame 120. The support beam 128 can extend from the base 129 to allow limited vertical movement of the link bracket 224 with respect to the upper frame 130 and the base 129 of the first frame 120. At the same time, the substantial rigid connection between the common link plate 121 of the second front mount configuration 230 and the second portion 120b of the first frame 120 substantially immobilizes the common link plate 121 with respect to the upper frame 130 and the base 129 of the first frame 120.

Further, during normal testing procedures, the interface 18 of the flex member 10 can move with respect to the first frame 120 with the limiting pin 20 freely traveling within the vertical slots 24a, 24b by way of the limiting ears 22a, 22b. However, in the event of an engine failure or test event, the limiting pin 20 limits the extent to which the interface 18 may move relative to the first frame 120; thereby protecting the flex member 10 from excessive stress loads that may otherwise damage the flex member 10.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A test apparatus comprising:
a jet engine;
a first frame configured to support the jet engine; and
means for flexibly coupling the jet engine to the first frame to allow movement between the jet engine and the first frame during a test procedure.

2. The test apparatus of claim 1, further comprising a second frame substantially rigidly attached to the first frame, wherein the second frame is configured for mounting to a test stand.

3. The test apparatus of claim 1, further comprising means for limiting the movement of the jet engine with respect to the first frame.

4. The test apparatus of claim 1, wherein a rear portion of the jet engine is flexibly coupled to the first frame by the means for flexibly coupling for allowing movement between the rear portion of the jet engine and the first frame during a test procedure, and wherein a front portion of the jet engine is substantially rigidly coupled to the first frame.

5. A test apparatus comprising:
a jet engine;
a first frame configured to support the jet engine;
a flex member including a mount interface coupled to the jet engine and configured to apply a force in a first direction to counteract a weight of the jet engine;
a first attachment element pivotally coupling the flex member to the first frame about a first axis extending substantially perpendicular to the first direction; and
a second attachment element positioned between the first attachment element and the mount interface and pivotally coupling the flex member to the first frame about a second axis extending substantially parallel with respect to the first axis,
wherein the flex member provides a cantilever support for flexibly supporting the jet engine with respect to the first frame.

6. The test apparatus of claim 5, further comprising a second frame substantially rigidly attached to the first frame, wherein the second frame is configured for mounting to a test stand.

7. The test apparatus of claim 5, wherein a rear portion of the jet engine is flexibly coupled to the first frame by the flex member, and wherein a front portion of the jet engine is substantially rigidly coupled to the first frame.

8. The test apparatus of claim 5, the first frame includes a base and a support beam extending from the base.

9. The test apparatus of claim 8, wherein a rear portion of the jet engine is flexibly coupled to the base of the first frame by the flex member, and wherein a front portion of the jet engine is substantially rigidly coupled to the first frame.

10. The test apparatus of claim 9, wherein the front portion of the jet engine is substantially rigidly coupled to the base of the first frame.

11. The test apparatus of claim 9, wherein the front portion of the jet engine is substantially rigidly coupled to the support beam of the first frame.

12. The test apparatus of claim 9, wherein the front portion of the jet engine is substantially rigidly coupled to the base and the support beam of the first frame.

13. The test apparatus of claim 9, wherein the front portion of the jet engine is substantially rigidly coupled to a first portion and a second portion of the first frame, wherein the support beam includes the first portion and the base includes the second portion, and wherein the rear portion of the jet engine is flexibly coupled to a third portion of the first frame, wherein the base includes the third portion and wherein the second portion is located between the first and third portions of the first frame.

14. The test apparatus of claim 9, wherein the support beam provides a cantilever support for a front portion of the jet engine.

15. A test apparatus configured to support a jet engine comprising:
a frame;
a flex member including an elongated member extending between a first portion coupled to the frame and a mount interface configured to be coupled to a jet engine, wherein the elongated member is configured to flex to allow movement of the mount interface with respect to the frame along a first direction during a test procedure;
a first attachment element pivotally coupling the first portion of the flex member to the frame about a first axis extending substantially perpendicular to the first direction; and
a second attachment element positioned between the first attachment element and the mount interface and pivotally coupling the first portion of the flex member to the first frame about a second axis extending substantially parallel with respect to the first axis.

16. The test apparatus of claim 15, further comprising a limiting element configured to limit movement of the mount interface with respect to the frame.

17. The test apparatus of claim 15, wherein the frame includes an interior area and the flex member is at least partially positioned within the interior area of the frame.

18. The test apparatus of claim 15, wherein the first attachment element comprises a first pivot pin and the second attachment element comprises a second pivot pin.

19. A test apparatus configured to support a jet engine comprising:
a frame;
a flex member including an elongated member extending between a first portion coupled to the frame and a mount interface configured to be coupled to a jet engine, wherein the elongated member is configured to flex to allow movement of the mount interface with respect to the frame during a test procedure; and
a limiting element configured to limit movement of the mount interface with respect to the frame.

20. The test apparatus of claim 19, wherein the flex member includes an elongated slot and the limiting element comprises a limit pin extending through the elongated slot.
